(19) United States
(12) Patent Application Publication
(10) Pub. No.: US 2012/0160163 A1
(43) Pub. Date: Jun. 28, 2012

(54) ROBOT ARM AND ROBOT USING THE SAME

(75) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/231,886

(22) Filed: Sep. 13, 2011

(30) Foreign Application Priority Data
Dec. 27, 2010 (CN) 201010607315.4

(51) Int. Cl. B25J 17/02; B05C 11/00

(52) U.S. Cl. 118/696; 74/490.06; 901/26; 901/29; 901/43

(57) ABSTRACT

A robot arm includes a support, a wrist joint rotatably connected to the support, a distal joint rotatably connected to the wrist joint, a first driving mechanism driving the wrist joint, and a second driving mechanism driving the distal joint. The first driving mechanism comprises a first input shaft connected to the wrist joint via two bevel gears, and the first driving mechanism drives the wrist joint to rotate relative to the support. The second driving mechanism comprises a second input shaft connected to the distal joint via at least four bevel gears, and the second driving mechanism drives the distal joint to rotate relative to the wrist joint. The robot arm is sealed and defines a conduit for allowing a plurality of pipes and cables to pass through.

### BACKGROUND

1. Technical Field

The present disclosure relates generally to robot arms and, particularly, to a robot arm and a robot using the same.

2. Description of Related Art

Industrial robots, particularly painting robots have many associated pipes and cables that often get painted by overspray. Before the overspray has a chance to dry, dust and other contaminants may adhere to the paint and later transfer to the work pieces.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of a robot arm.

FIG. 2 is a cross-sectional view of the robot arm taken along line II-II of FIG. 1.

FIG. 3 is an enlarged view of a circled portion III of FIG. 2.

### DETAILED DESCRIPTION

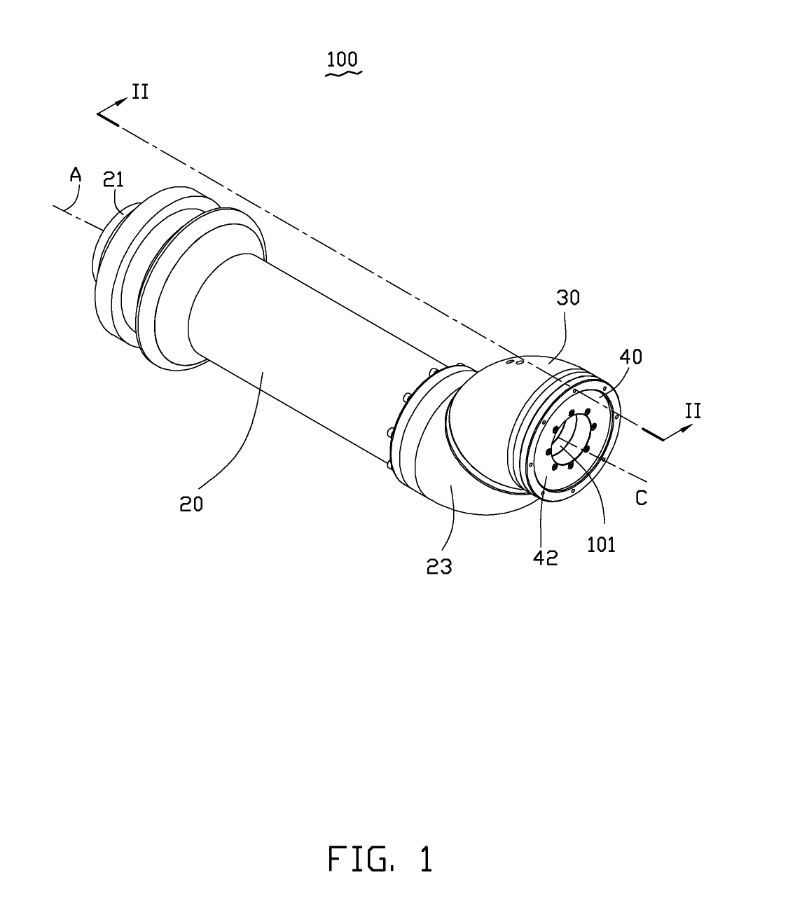

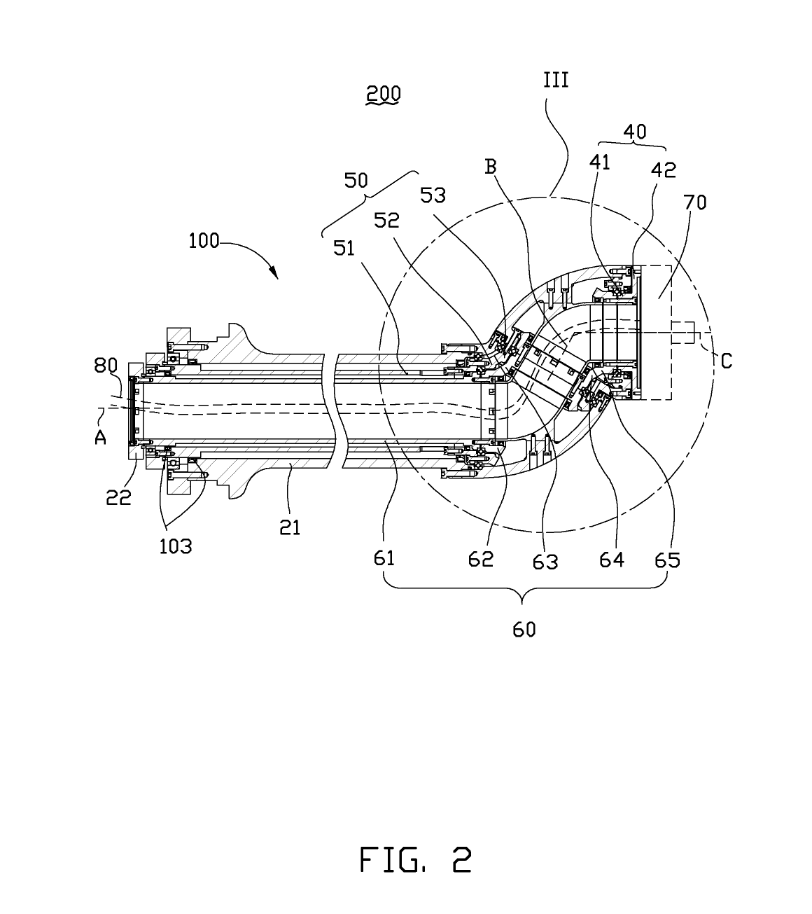

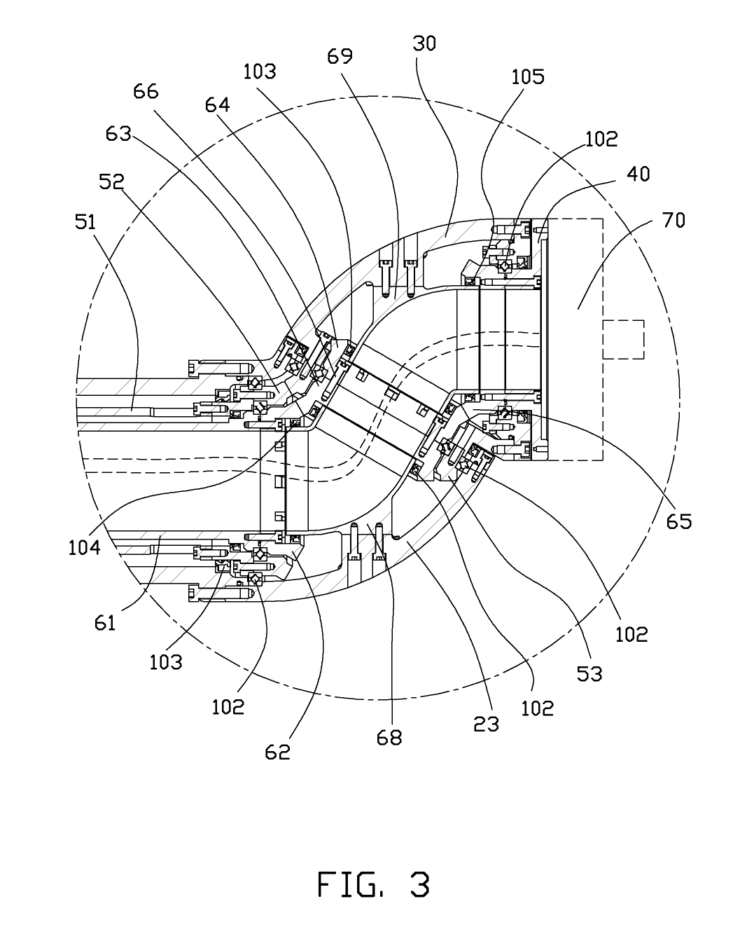

Referring to FIGS. 1 through 3, one embodiment of a robot arm 100 is utilized in a robot 200. The robot arm 100 includes a support 20, a wrist joint 30, a distal joint 40, a first driving mechanism 50, and a second driving mechanism 60. The wrist joint 30 is rotatably connected to the support 20, and the distal joint 40 is rotatably connected to the wrist joint 30. The first driving mechanism 50 drives the wrist joint 30 to rotate, and the second driving mechanism 60 drives the distal joint 40 to rotate. The robot 200 further includes a painting mechanism 70, and a plurality of pipes and cables 80 connected to the painting mechanism 70. The painting mechanism 70 is mounted to the distal joint 40. The robot 200 includes various electronic components to perform corresponding function and features, however for simplicity, in the following embodiment, only the robot arm 100 is described.

The support 20 is rotatable around a first rotation axis A. The wrist joint 30 is rotatable around a second rotation axis B driven by the first driving mechanism 50. The distal joint 40 is rotatable around a third rotation axis C driven by the second driving mechanism 60. In this embodiment, the rotation axis C is parallel to but offset from the rotation axis A, and an included angle defined by the first rotation axis A relative to the second rotation axis B is 45°. Motors for driving the support 20, the first driving mechanism 50, and the second driving mechanism 60 are not shown in the illustrated embodiment.

The robot arm 100 is sealed against contamination by dust and paint, and defines a conduit 101. The conduit 101 extends through two ends of the robot arm 100. The pipes and cables 80, such as pipes for delivering paint or supplying high pressure gas, and cables for transmitting signal or electricity, are connected to the painting mechanism 70 through the conduit 101. That is, the pipes and cables 80 can be encased inside the sealed robot arm 100, thus preventing the pipes and cables 80 from being abraded and contaminated, thereby enhancing the reliability of the robot 200 and decreasing maintenance of the pipes and cables 80.

In the illustrated embodiment, the support 20, the wrist joint 30, and the distal joint 40 are substantially tube-shaped. The support 20 includes a straight sleeve 21, an end cover 22 fixed to an end of the straight sleeve 21, and an arced sleeve 23 fixed to the other end of the straight sleeve 21. The wrist joint 30 is an arced tube in this embodiment. The wrist joint 30 and the arced sleeve 23 are rotatably connected, and cooperatively form a S-shaped structure. The distal joint 40 includes a connecting shaft 41 and a flange 42 radially extending from an outer peripheral of the connecting shaft 41. The connecting shaft 41 is rotatably received in the wrist joint 30, and the painting mechanism 70 is mounted on the flange 42 at a side of the flange 42 opposite to the connecting shaft 41.

The first driving mechanism 50 includes a first input shaft 51, a first bevel gear 52, and a second bevel gear 53. The first bevel gear 52 is non-rotatably connected to the first input shaft 51. The first bevel gear 52 and the second bevel gear 53 are meshed with each other for rotating the wrist joint 30.

The second driving mechanism 60 includes a second input shaft 61, a third bevel gear 62, a fourth bevel gear 63, a fifth bevel gear 64, and a sixth bevel gear 65. The second input shaft 61 is rotatably positioned in the first input shaft 51. The third bevel gear 62 is non-rotatably connected to the second input shaft 61, and the fourth bevel gear 63 is meshed with the third bevel gear 62. The fourth bevel gear 63 and the fifth bevel gear 64 are coaxial and positioned back to back to one another. The fifth bevel gear 64 and the sixth bevel gear 65 are meshed with each other for rotating the distal joint 40. The first bevel gear 52 and the third bevel gear 62 are coaxial, and the second bevel gear 53 and the fourth bevel gear 63 are coaxial.

In the illustrated embodiment, the first bevel gear 52 is connected to an end of the first input shaft 51. The third bevel gear 62 is connected to an end of the second input shaft 61. The first bevel gear 52 is sleeved on the third bevel gear 62, and the second bevel gear 53 is sleeved on the fourth bevel gear 63. The fourth bevel gear 63 and the fifth bevel gear 64 are fixed via a plurality of screws 66. The connecting shaft 41 of the distal joint 40 is fixed to the sixth bevel gear 65. It should be pointed out that the second input shaft 61 may drive the distal joint 40 to rotate by more than four bevel gears.

The robot arm 100 further includes a plurality of bearings 102 for smoother rotation. The bearings 102 are positioned between the first input shaft 51 and the straight sleeve 21, between the first input shaft 51 and the second input shaft 61, between the first bevel gear 52 and the arced sleeve 23, between the first bevel gear 52 and the third bevel gear 62, between the second bevel gear 53 and the wrist joint 30, between the second bevel gear 53 and the fourth bevel gear 63, and between the sixth bevel gear 65 and the wrist joint 30, respectively. The bearings 102 are sized according to actual needs.

In the illustrated embodiment, the robot arm 100 further includes a plurality of gaskets such as O-rings 103 for good sealing. The O-rings 103 are respectively positioned between the support 20 and the wrist joint 30, between the wrist joint 30 and the distal joint 40, between the first input shaft 51 and the support 20, and between the first input shaft 51 and the second input shaft 61.

The robot arm 100 further includes a first sealing tube 68 and a second sealing tube 69. The first sealing tube 68 is positioned between the third bevel gear 62 and the fourth bevel gear 63, and the first sealing tube 68 is fixed to the arced sleeve 23. The second sealing tube 69 is positioned between the fifth bevel gear 64 and the sixth bevel gear 65, and the second sealing tube 69 is fixed to the wrist joint 30. The robot arm 100 further includes two O-rings 104 and two O-rings 105. Two O-rings 104 are respectively positioned between outer surface of the first sealing tube 68 and the third bevel gear 62, and between outer surface of the first sealing tube 68 and the fourth bevel gear 63. Two O-rings 105 are respectively positioned between outer surface of the second sealing tube 69 and the fifth bevel gear 64, and between outer surface of the second sealing tube 69 and the sixth bevel gear 65.

The first input shaft 51 is sleeved on the second input shaft 61, and a size of the bevel gears 52, 53, 62, 63, 64, and 65 can be relatively small to economize on space, thus the robot arm 100 can be more compact, and an amount of space for moving of the distal joint 40 can be relatively large.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A robot arm, comprising:
a support;
a wrist joint rotatably connected to the support;
a distal joint rotatably connected to the wrist joint;
a first driving mechanism driving the wrist joint, the first driving mechanism comprising a first input shaft rotatably positioned in the support, a first bevel gear non-rotatably connected to the first input shaft, and a second bevel gear meshed with the first bevel gear, and driving the wrist joint to rotate; and
a second driving mechanism driving the distal joint, the second driving mechanism comprising a second input shaft rotatably positioned in the first input shaft of the first driving mechanism, a third bevel gear non-rotatably connected to the second input shaft, a fourth bevel gear meshed with the third bevel gear, a fifth bevel gear fixed to the fourth bevel gear, and a sixth bevel gear meshed with the fifth bevel gear, and driving the distal joint to rotate;
wherein the robot arm is sealed and defines a conduit therein for allowing a plurality of pipes and cables to pass through.

2. The robot arm of claim 1, wherein the support rotates around a first rotation axis, the wrist joint rotates around a second rotation axis, and the distal joint rotates around a third rotation axis.

3. The robot arm of claim 2, wherein the third rotation axis is parallel to but offset from the first rotation axis, and an included angle defined by the first rotation axis relative to the second rotation axis is 45°.

4. The robot arm of claim 1, wherein the support comprises a straight sleeve, an end cover fixed to an end of the straight sleeve, and an arced sleeve fixed to the other end of the straight sleeve.

5. The robot arm of claim 4, wherein the wrist joint is an arced tube, and the wrist joint is rotatably connected to the arced sleeve.

6. The robot arm of claim 1, wherein the first bevel gear and the third bevel gear are coaxial, and the second bevel gear and the fourth bevel gear are coaxial.

7. The robot arm of claim 1, wherein the first bevel gear is sleeved on the third bevel gear, and the second bevel gear is sleeved on the fourth bevel gear.

8. The robot arm of claim 1, wherein the support, the wrist joint, the distal joint, the first input shaft, and the second input shaft are substantially tube-shaped, and cooperatively define the conduit.

9. The robot arm of claim 1, wherein the robot arm further comprises a first sealing tube positioned between the third bevel gear and the fourth bevel gear, and a second sealing tube positioned between the fifth bevel gear and the sixth bevel gear; the first sealing tube is fixed to the support, and the second sealing tube is fixed to the wrist joint.

10. The robot arm of claim 1, wherein the robot arm further comprises a plurality of bearings positioned between the first input shaft and the support, and between the first input shaft and the second input shaft, respectively

11. The robot arm of claim 1, wherein the robot arm further comprises a plurality of O-rings, the O-rings are positioned between the support and the wrist joint, between the wrist joint and the distal joint, between the first input shaft and the support, and between the first input shaft and the second input shaft, respectively.

12. A robot arm, comprising:
a support;
a wrist joint rotatably connected to the support;
a distal joint rotatably connected to the wrist joint;
a first driving mechanism driving the wrist joint; and
a second driving mechanism driving the distal joint;
wherein the first driving mechanism comprises a first input shaft connected to the wrist joint via two bevel gears, and the first driving mechanism drives the wrist joint to rotate relative to the support; the second driving mechanism comprises a second input shaft connected to the distal joint via at least four bevel gears, and the second driving mechanism drives the distal joint to rotate relative to the wrist joint; the robot arm is sealed and defines a conduit for allowing a plurality of pipes and cables to pass through.

13. The robot arm of claim 12, wherein the support is substantially tube-shaped, and the first input shaft is rotatably seated in the support via a bearing.

14. The robot arm of claim 13, wherein the first input shaft is substantially tube-shaped, and the second input shaft is rotatably seated in the first input shaft via a bearing.

15. The robot arm of claim 12, wherein the two bevel gears are meshed with each other, and the two bevel gears comprises a first bevel gear and a second bevel gear; the first bevel gear is non-rotatably connected to the first input shaft, and the second bevel gear drives the wrist joint to rotate.

16. The robot arm of claim 15, wherein the second input shaft is connected to the distal joint via four bevel gears, and the four bevel gears comprise a third bevel gear non-rotatably connected to the second input shaft, a fourth bevel gear meshed with the third bevel gear, a fifth bevel gear fixed to the fourth bevel gear, and a sixth bevel gear meshed with the fifth bevel gear and driving the distal joint to rotate.

17. A robot, comprising:
a support;
a wrist joint rotatably connected to the support;
a distal joint rotatably connected to the wrist joint;
a first driving mechanism driving the wrist joint;
a second driving mechanism driving the distal joint;
a painting mechanism mounted on the distal joint; and
a plurality of pipes and cables connected to the painting mechanism;
wherein the robot is sealed and defines a conduit inside for allowing the pipes and cables to be connected to the painting mechanism through the conduit.

18. The robot of claim 17, wherein the first driving mechanism comprises a first input shaft rotatably positioned in the support, a first bevel gear non-rotatably connected to the first input shaft, and a second bevel gear meshed with the first bevel gear and driving the wrist joint to rotate; the second driving mechanism comprises a second input shaft rotatably positioned in the first input shaft of the first driving mechanism, a third bevel gear non-rotatably connected to the second input shaft, a fourth bevel gear meshed with the third bevel gear, a fifth bevel gear fixed to the fourth bevel gear, and a sixth bevel gear meshed with the fifth bevel gear and driving the distal joint to rotate.

19. The robot of claim 17, wherein the support comprises a straight sleeve, an end cover fixed to an end of the straight sleeve, and an arced sleeve fixed to the other end of the straight sleeve.

20. The robot of claim 17, wherein the robot arm further comprises a plurality of O-rings, the O-rings are positioned between the support and the wrist joint, between the wrist joint and the distal joint, between the first input shaft and the support, and between the first input shaft and the second input shaft, respectively.
